(19) United States
(12) Patent Application Publication
(10) Pub. No.: US 2006/0008308 A1
(43) Pub. Date: Jan. 12, 2006

(54) Method of processing image; apparatus for image processing; apparatus for processing character information; program; and memory medium

(75) Inventor: Hiroyasu Kurashina, Matsumoto-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/137,213

(22) Filed: May 24, 2005

(30) Foreign Application Priority Data
Jul. 8, 2004 (JP) 2004-201694

(51) Int. Cl. B41J 2/00

(52) U.S. Cl. 400/109

(57) ABSTRACT

In a method of processing an image, a raised-letter image which visually represents a raised letter to be embossed on a target sheet material is displayed on a display screen in a scrolled manner.

### BACKGROUND OF THE INVENTION

1. Field of the Invention

This invention relates to: a method of processing an image for displaying a visual representation of the result of embossing of raised letters; an apparatus for image processing; an apparatus for processing characters; a program; and a memory medium.

2. Description of the Related Art

Conventionally, there is known a raised-letter label in which raised letters (Braille) which can be recognized by a person having a handicap in eyesight and written letters (i.e., ordinary letters printed, e.g., in ink as compared with raised letters) are disposed in parallel with each other on the same target for printing (e.g., a tape) to enable recognition by both the eyesight-handicapped person and one having no such handicap. In this specification, the term “target (or target sheet material)” is used in the meaning of an “object”, i.e., an object to which processing such as embossing and/or printing is performed.

In an ordinary word processor, or the like, a preview display or display of visual representation is possible to enable to know, prior to actual printing, the visual representation of the result of printing of the written letters. However, in the raised letters, the number of characters (number of frames) becomes large because Japanese “hiragana”, or the like, must be made available, aside from the alphabets and voiced sounds. Further, the size of each of the frames and the distance between respective adjacent frames are made large enough to facilitate reading (or understanding) through touching with fingers (according to the specification by private companies). Therefore, as compared with the character string of written letters with Chinese characters, or the like, the raised-letter string is likely to become long. As a result, there was a problem in that the entire visual representation of the raised-letter string, for the purpose of preview, or the like, was difficult especially with a small display screen.

### SUMMARY OF THE INVENTION

In view of the above problem, this invention has an advantage of providing: a method of processing an image; an apparatus for image processing; an apparatus for processing character information; a program; and a memory medium, which enable easy grasping of the visual representation of the result of performing the embossing of raised letters.

According to one aspect of this invention, there is provided a method of processing an image comprising displaying a raised-letter image which visually represents a raised letter to be embossed on a target sheet material. The displaying is made on a display screen in a scrolled manner.

According to this method, the raised-letter image which is the visual representation of the raised letter is displayed in a scrolled manner. In this case, since the displaying is made in a scrolled manner, the entire image can be grasped even with a small-sized display screen such as in a small device or even in case of displaying an image of a raised letter (raised-letter array) which is likely to become long.

According to another aspect of this invention, there is provided a method of processing an image comprising displaying images of both a raised letter and a written letter to be embossed and to be printed, respectively, on a common target sheet material as a single unit in a scrolled manner. A raised-letter image which visually represents the raised letter and a written-letter image which visually represents the written letter are displayed in scroll modes which are different from each other.

According to still another aspect of this invention, there is provided an apparatus for image processing in which images of both a raised letter and a written letter to be embossed and to be printed, respectively, on a common target sheet material are displayed as a single unit on a display screen in a scrolled manner. The apparatus comprises: raised-letter scrolling means for displaying in a scrolled manner a raised-letter image which visually represents the raised letter; written-letter scrolling means for displaying in a scrolled manner a written-letter image which visually represents the written letter; control means for controlling the raised-letter scrolling means and the written-letter scrolling means. The control means displays the raised-letter image and the written-letter image in scroll modes which are different from each other.

According to the above method and apparatus, the images of the raised letter and the written letter to be embossed and to be printed, respectively, are displayed as a single unit in a scrolled manner. Since the display is made in a scrolled manner, the entire image can be grasped even in a small display screen and even in a relatively long image. In addition, since both the written letter and the raised letter are displayed as a single unit in a scrolled manner, the image of the written letter and the image of the raised letter on the common target sheet material can be grasped at the same time. Further, since they are displayed in scroll modes which are different from each other, they can be discriminated from each other due to the difference in scroll modes even in case the written letter and the raised letter are displayed in an overlapped manner. As the different scroll modes, there can be considered an example having different scroll speeds, an example in which one scrolls in a flushing manner and the other scrolls in an ordinary manner, or an example in which the scroll is made in circulation in different vertical or horizontal directions.

Preferably, the raised-letter image and the written-letter image are displayed in a scrolled manner by respective intermittent movements, and the scroll mode of the raised letter and the scroll mode of the written letter are different from each other in a movement cycle of the intermittent movements.

According to this method, the scrolled displaying is performed by the respective intermittent movements and the movement cycle in the intermittent movement on the side of the raised letter and that on the side of the written letter are different from each other. Therefore, during scroll displaying, the relative positions between the written letter and the raised letter are deviated. As a result, even in case the written letter and the raised letter are disposed in an overlapped manner, i.e., even in case both the images are in a positional relationship to cause difficulty in reading or recognizing, the difference in movements in the written letter and in the raised letter may sometimes realize, on the way, a state in which the letters are recognizable. In this manner, the respective images can be grasped.

Preferably, one movement cycle is integer times of the other movement cycle.

According to this method, since one movement cycle is set to be integer times of the other movement cycle, synchronization can easily be attained, resulting in an easy control of the scroll displaying.

Preferably, a unit movement distance according to the one movement cycle is integer times of a unit movement distance according to the other movement cycle.

According to this method, a unit movement distance according to the one movement cycle is integer times of a unit movement distance according to the other movement cycle. Therefore, if the scroll is made in the same direction, that cycle of movement which is behind will be caught up with that cycle of movement which is higher in speed each time the scroll movement is made.

According to another aspect of this invention, there is provided an apparatus for processing character information comprising: image processing means for performing the above-described method of processing an image; embossing means for embossing the raised letter on the target sheet material; and printing means for printing the written letter on the target sheet material.

According to this apparatus, written-letter printing and raised-letter embossing can be performed, and the above-described methods can be performed. Therefore, the result of performing the actual raised-letter embossing and the written-letter printing can be grasped in visual representation before actually performing the embossing and printing, respectively.

According to another aspect of this invention, there is provided a program capable of performing the above-described method of processing an image. Further, the memory medium according to this invention stores the above-described program in a manner readable by an apparatus which is capable of being processed by a program.

Since the program is capable of performing the above-described methods and since the memory medium stores the above-described program in a manner readable by an apparatus which is capable of being processed by a program, the result of performing the raised-letter embossing and the result of written-letter printing can be easily grasped.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is a perspective external view of a label forming apparatus according to this invention;

GIG. 2 is a perspective external view of the label forming apparatus in FIG. 1 with the lid left open;

FIG. 3 is a block diagram of a control system of the label forming apparatus in FIG. 1;

FIG. 4A is a plan view explaining six-point raised letters and FIG. 4B is a sectional view of an embossed portion;

FIG. 5A is a plan view of an embossing unit and FIG. 5B is a side view, partially sown in section, thereof;

FIG. 6 is a plan view explaining the tape feeding at raised-letter embossing section;

FIG. 7 is a flow chart showing the entire processing by the label forming apparatus;

FIGS. 8A through 8C are supplemental schematic views relating to processing modes in FIG. 7;

FIGS. 9A through 9C are supplemental schematic views relating to the difference in tape width in FIG. 7;

FIGS. 10A through 10E are schematic views for explaining an example of label forming and of scroll display;

FIGS. 11A through 11G are schematic views for explaining scroll displays which are different between the written-letter image and the raised-letter image;

FIGS. 12A through 12D are schematic views of another example which are similar to those in FIGS. 10A through 10E;

FIGS. 13A through 13C are explanatory views visually representing the image in FIG. 12 in dot matrix; and

FIGS. 14A through 14G are those explanatory views corresponding to FIGS. 13A through 13C which are similar to FIGS. 11A through 11G.

### DETAILED DESCRIPTION OF THE PREFERRED EMBODIMENTS

With reference to the accompanied drawings, a description will now be made about an embodiment of a label forming apparatus (apparatus for processing character information).

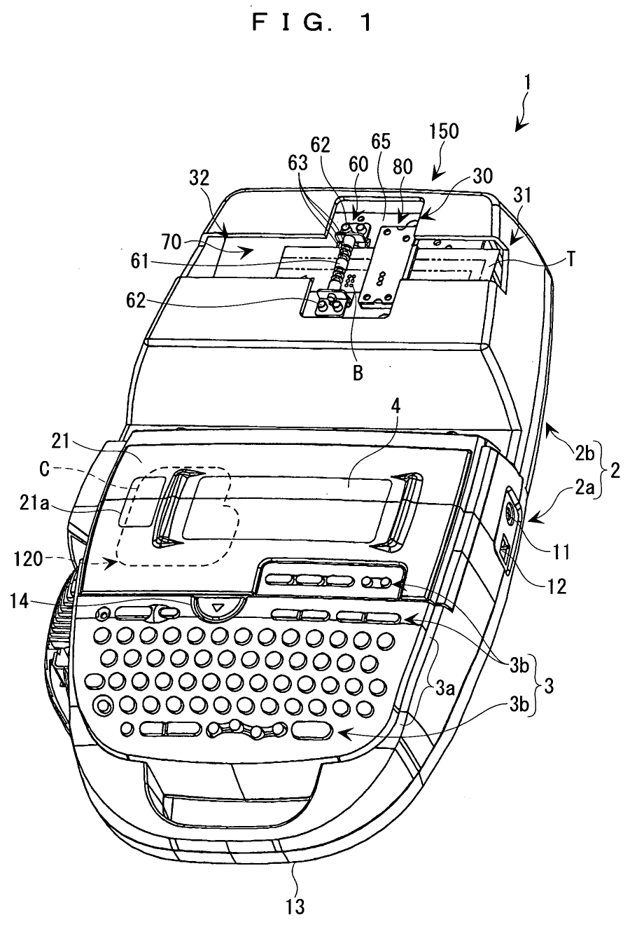

As shown in FIGS. 1 and 2, the label forming apparatus 1 has an outside shell which is made of an apparatus casing 2 having a handle 13. The apparatus casing 2 is made up of a front case 2a and a rear case 2b which are integrally formed. The front case 2a has a written-letter (or ink-character) printing section 120 for performing written-letter printing on a tape (target sheet material, T) which is fed or paid out of a tape cartridge C. The rear case 2b has a raised letter (or Braille) embossing section 150 for performing embossing on the tape T which has been printed with written letters and manually fed or inserted by a user.

The front case 2a is provided, on its front upper face, with a keyboard 3 which has disposed therein various input keys and, on its rear upper face, with an open/close lid 21. The open/close lid 21 is provided with an elongated rectangular display 4, and has formed in an inner left portion thereof a cartridge mounting part 6 (written-letter printing section 120) in a recessed manner for mounting therein a tape cartridge C. The tape cartridge C is detachably mounted in a state in which the open/close lid 21 is left open by depressing the lid open button 14. The tape cartridge C is further provided with a peep hole 21a for visually recognizing the mounting or absence of the tape cartridge C in a state in which the open/close lid 21 is kept closed.

In a right part of the front case 2a, there are formed a power supply port 11 for connection to a power supply source, and a connection port (interface) 12 for connection with an outside apparatus such as a personal computer, or the like (not illustrated). It is thus so arranged that the written-letter printing and raised-letter embossing can be performed by connection to the outside apparatus based on the character information therefrom. In a left part of the front case 2a, there is formed a printing tape discharge port 22 which is communicated with the cartridge mounting part 6 and the outside. There is provided a tape cutter 142 in a manner to face this printing tape discharge port 22 so that the tape T fed out of the written-letter printing section 120 can be cut. As a result of cutting the rear end of the tape T with the tape cutter 19, the tape T that has been printed with the written letters is discharged out of the printing tape discharge port 22.

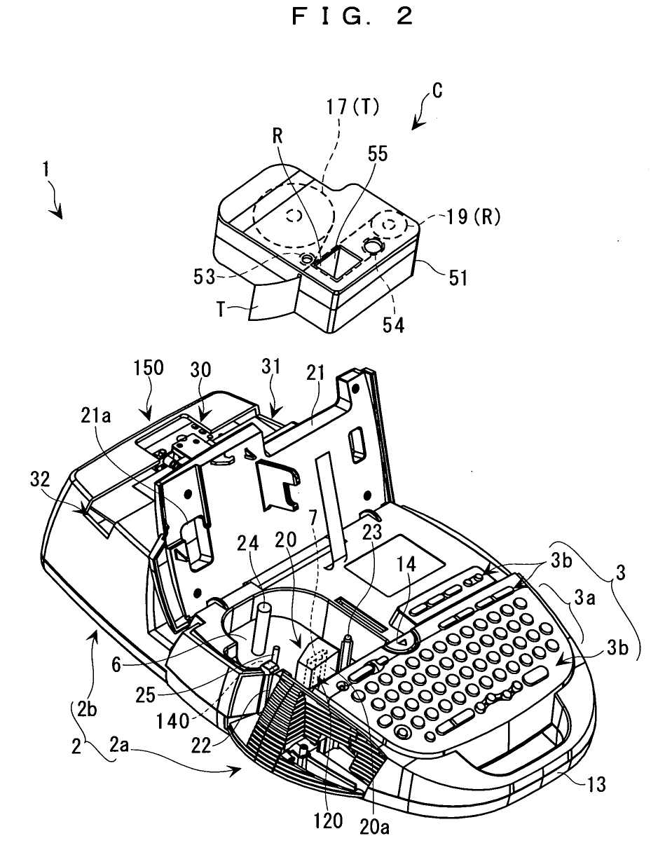

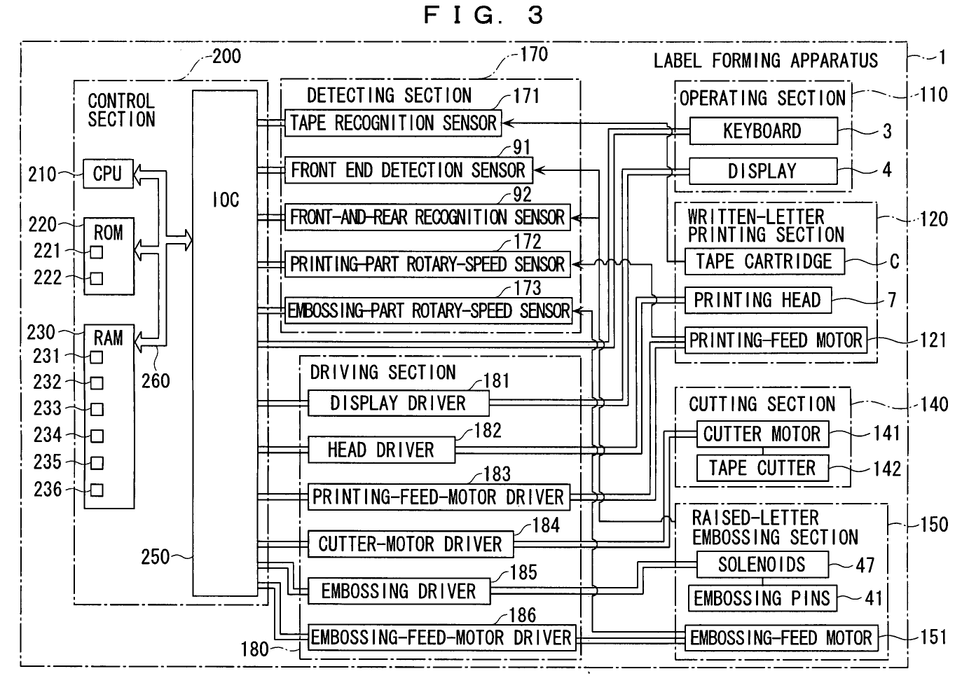

As shown in FIG. 3, the label forming apparatus 1 is made up of: an operating section 110 which has the keyboard 3 and the display 4 as a basic structure as seen from the control system, and controls the man-machine interface such as displaying of the character information and various information; written-letter printing section 120 which has the tape cartridge C, a printing head 7, and printing-feed motor 121, and performs the written-letter printing on the tape T while feeding the tape T and an ink ribbon R; and a cutting section 140 which has a tape cutter 19 and a cutter motor 141 for driving the tape cutter 19, and cuts the printed tape T.

The label forming apparatus 1 is further made up of: the raised-letter (Braille) embossing section 150 which has solenoids 47, embossing pins 41, and embossing-feed motor 151, and performs embossing of the raised letters on the tape T while feeding the tape T; and a detecting section 170 which performs various detections and has a tape recognition sensor 171 for detecting the kind of the tape T (tape cartridge C), a front end detection sensor 91 for detecting the front end of the tape T at the raised-letter embossing section 150, a front-and-rear recognition sensor 92 for detecting, at the raised-letter embossing section 150, front-and-rear recognizing information D which is printed on the tape T, a printing-part rotary-speed sensor 172 for detecting the rotary speed of the printing-feed motor 121, and an embossing-part rotary-speed sensor 173 for detecting the rotary speed of the embossing-feed motor 151.

The label forming apparatus 1 is further made up of: a driving section 180 having a display driver 181, a head driver 182, a printing-feed-motor driver 183, a cutter-motor driver 184, an embossing driver 185, and an embossing-feed-motor driver 186; and a control section 200 which performs an overall control over the label forming apparatus 1.

The control section 200 is provided with a CPU 210, a ROM 220, a RAM 230, and an input/output control apparatus (hereinafter referred to as an “input/output controller, IOC) 250, and is connected together by an internal bus 260. The ROM 220 has: a control program block 221 which stores therein a program for controlling various processing such as written-letter processing, raised-letter processing, or the like, by the CPU 210; and a control date block 222 which stores therein character font data for performing written-letter printing, raised-letter font for performing embossing of raised letters, data for performing printing of front-and-rear recognizing information D in the form of written letters, control data for controlling the embossing of the raised letters, or the like. The written-letter font data may alternatively be stored not in the ROM 220 but in a separate CG-ROM.

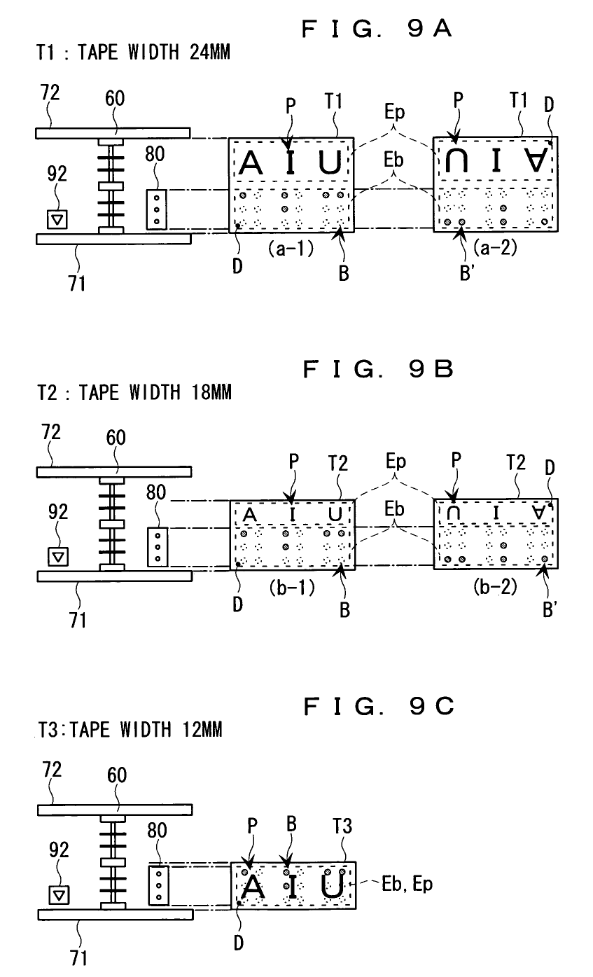

The RAM 230 is made up of: a various work area block 231 which is used as a flag, or the like; a written-letter printing data block 232 which stores therein generated written-letter printing data; a raised-letter embossing data block 233 which stores therein generated raised-letter embossing data; a display data block 234 which stores therein display data for displaying on the display 4; a layout block 235 for storing therein layout of the set written-letter printing region (printing layout portion) Ep and raised-letter embossing region (embossing layout portion) Eb; and inversed raised-letter data block 236 which stores therein inversed raised-letter data B′ (see, e.g., FIG. 9A) which is used in embossing the raised-letter data by rotating it by 180 degrees according to the set layout. The RAM 230 is used as working regions for control processing and is constantly backed up to always keep the stored data even in case of power failure.

The IOC 250 has assembled therein a logic circuit which supplements the function of the CPU 210 and also handles interface signals with various peripheral circuits in the form of a gate array, custom LSI, or the like. According to this arrangement, the IOC 250 takes in input data and control data from the keyboard 3, and various values as detected by the sensors in the detecting section 170 as they are or with due processing. Also, in interlocking with the CPU 210, the IOC 250 outputs the control signals as outputted from the CPU 210 to the internal bus 260, to the driving section 180 as they are or with due processing.

According to the above arrangement, the CPU 210 inputs various signals/data from each part within the label forming apparatus 1 according to the control program inside the ROM 220, and also processes various data inside the RAM 230 according to the inputted various signals/data to thereby output the various signals/data into each part of the label forming apparatus 1 through the IOC 250. The control of the written-letter processing and the raised-letter processing is thus performed.

For example, when the character information is inputted from the keyboard 3, the written-letter printing data P and the raised-letter embossing data B are generated based thereon. Adjustments of lengths, or the like, are made between both the data, depending on necessity, to thereby prepare inversed raised-letter data B′ (see, e.g., FIG. 9A). The written-letter printing data before or after adjustment (inclusive of the margin data) P is stored in the written-letter printing data block 232, and also the raised-letter embossing data before or after adjustment (inclusive of the margin data) B is stored in the raised-letter embossing data block 233, and the inversed raised-letter data B′ is stored in the inversed raised-letter data block 236.

Once a command is received from the keyboard 3 to print written letters and to emboss raised letters, the driving of the printing-feed motor 121 is started. Depending on the result of detection by the printing-part rotary-speed sensor 172, the printing head 7 is driven. Written-letter printing is thus performed based on the written-letter printing data P. Also, based on the data stored in advance in the control data block 222, printing is performed of the front-and-rear recognizing information D of the tape T to be inserted or fed. Thereafter, based on the written-letter printing data, feeding is made of the tape (adjusted tape depending on necessity) by a predetermined length. The rear end of the tape is cut by the tape cutter 19 and the tape T is discharged out of the printing tape discharge port 22.

With reference to FIGS. 1 through 3, when the tape T is manually inserted or fed by the user in succession in the absence of reset operation or power-off operation, so that the tape T as cut into a rectangular piece is inserted into the embossing-tape inserting port 31, the embossing unit 80 and the tape feeding mechanism 60 are driven. Embossing is thus performed based on the raised-letter embossing data B or the inversed raised-letter data B′. Thereafter, upon completion of embossing, the adjusted predetermined length of tape that has been adjusted based on the raised-letter embossing data B, or the like, is fed by driving the embossing-feed motor 151. The tape T is thus discharged out of the embossed tape discharge port 32.

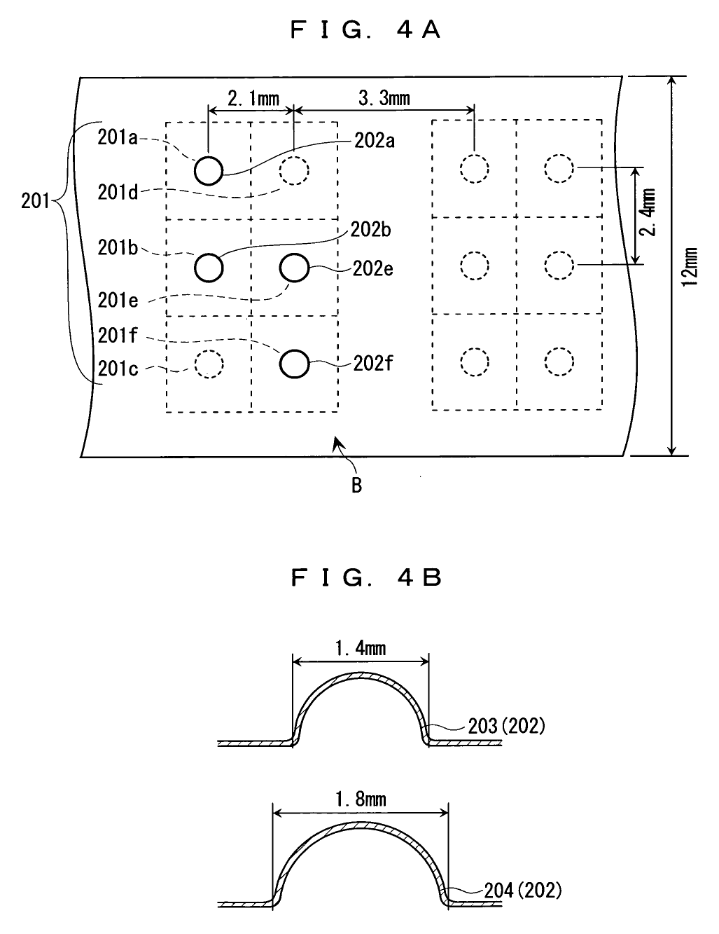

With reference to FIG. 4, a description will now be made about the raised letter or Braille B (six-point raised letter or raised letter made up of six raised points) which are to be formed on a tape T.

The specification about a single letter (a single frame) and a letter pitch (a distance between frames) ordinarily employed in a commercially available braillewriter or raised-letter typewriter is as follows. Namely, six-point letter B is made up of a frame 201 having six points (three vertically disposed points arranged in two rows horizontally separate from each other as seen in FIG. 4A). These six points are referred to as “point one” through “point six.” Depending on a pattern showing which particular points are embossed and which particular points are not among the six points, one frame 201 represents properties such as a single letter, voiced sound, or the like. In the example of FIG. 4A, points 1, 2, 5 and 6 are embossed, and points 3 and 4 are not embossed. As a result, the raised letter B thus formed conveys a character information representing a Japanese hiragana “SHI.”

Aside from the above-described six-point raised letter B, eight-point raised letter B (i.e., a raised letter made of a frame constituted by four vertical points arranged in two horizontally separated parallel rows) to represent Chinese characters. Description will be made here about an example of forming six-point raised letters B, but this invention is applicable to the label forming apparatus for forming eight-point raised letters.

The six-point raised letter B has a construction in which one frame 201 is divided into six 201a-201f made up of three vertically arranged embossing points disposed in horizontally separated two rows (3×2). They are disposed at a vertical pitch of about 2.4 mm and a horizontal pitch of about 2.1 mm within each frame 201. The pitch between respective frames is about 3.3 mm. In the example of FIG. 4A, among six embossing points 201a-201f, four embossing points 201a, 201b, 201e and 201f are selectively embossed so as to represent a Japanese hiragana “SHI.” As a result, four embossed projected portions 202a, 202b, 202e and 202f are formed on the tape T, each having a cross section of rounded corner of cylindrical, hemispherical, conical or quadrangular pyramid shape as shown in FIG. 4B. In order to emboss six-point raised letter B, a minimum tape width of 12 mm (tape T3) is required when counted based on the size (in the widthwise direction of the tape) of one frame 201.

The label forming apparatus 1 of this embodiment is provided with two kinds of interchangeable units as the embossing unit 80, one being for forming a small embossed projection 203 of about 1.4 mm in diameter and the other being for forming a large embossed projection 204 of about 1.8 mm in diameter. These two kinds of small and large embossed projections 203, 204 are selected depending on the uses to which they are put. For example, the small size embossed projection 203 is intended for a user who is accustomed to the reading of the raised letters B (e.g., one who is born blind), and the large size embossed projection 204 is intended for a beginner (e.g., one who has lost his or her eyesight in the course of life).

With reference to FIGS. 1 through 3, further details will be explained. The keyboard 3 has arranged therein character key group 3a, and function key group 3b which is used for designating various operation modes, or the like. The character key group 3a is for inputting character information so as to perform written-letter printing and raised-letter embossing, and has a full-key arrangement according to the layout of Japanese Industrial Standard (JIS). The function key group 3b includes: printing/execution key (printing key); feeding start key to command to start the feeding of the tape T at the raised-letter embossing section 150; embossing start key to manually perform embossing; mode key to select processing mode for performing written-letter printing and raised-letter embossing; layout key for setting the arrangement of the written-letter printing region (printing layout portion) Ep and raised-letter embossing region (embossing layout portion) Eb; and scroll key for displaying in a scrolled manner the result of layout before performing the printing, or the like. Aside from the above keys, the function key group 3b further includes the following keys: like in an ordinary word processor, such as a delete key for deleting the processing; cursor key for moving the cursor; enter key for finalizing the selection of alternatives in various selection screen, paragraph key to change to a new line, or the like.

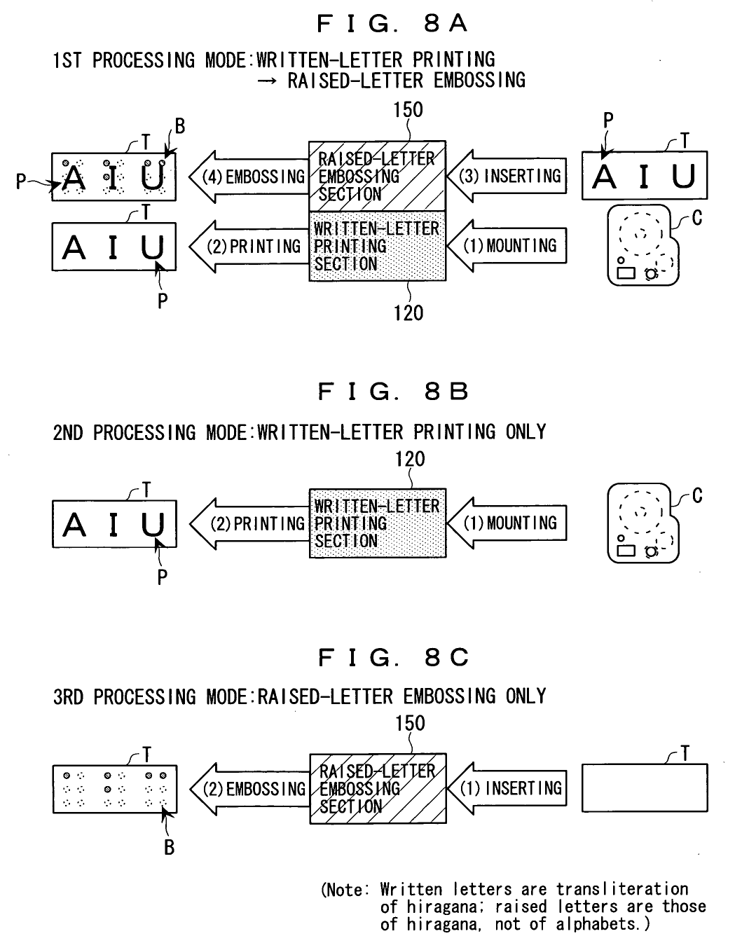

As the selection modes to be selected by the mode key, there are the following three modes, i.e.: a first processing mode in which written-letter printing and raised-letter embossing are performed based on the inputted character information (see FIG. 8A); a second processing mode in which only written-letter printing is performed based on the inputted character information (see FIG. 8B); and a third processing mode in which only the raised-letter embossing is performed based on the inputted character information (see FIG. 8C). It is to be noted that, in the illustrated examples, the written letters in FIGS. 8A, 9A, or the like, are transliteration of Japanese hiragana “A,” “I,” and “U” into corresponding alphabets, but that the raised letters are those of hiragana, not of alphabets. The alphabetical representation is partly to facilitate the understanding of inverted posture on the right side (a-2, b-2) in FIGS. 9A and 9B.

The display 4 is capable of displaying a display image of 192 dots×80 dots on an inside of a rectangle of about 12 cm wide (X-axis direction) and about 5 cm long (Y-axis direction), which is used in inputting the character information through the keyboard 3 and in preparing and editing the written-letter printing data and raised-letter embossing data. Various errors and messages (contents of commands, or the like) are displayed to thereby inform the user.

The cartridge mounting part 6 in the written-letter printing section 120 has: a head unit 20 containing therein the printing head 7 which contains a thermal head inside the head cover 20; a platen driving shaft 25 which lies opposite to the printing head 7; and a positioning projection 24 for positioning the tape reel 17. Under the cartridge mounting part 6, there is contained a printing-feed motor 121 which rotates the platen driving shaft 25 and a take-up drive shaft 23.

The tape cartridge C is constituted by a tape reel 17 and a ribbon reel 9 which are contained or housed inside the cartridge case 51. The tape T and the ink ribbon R are made in the same width. The tape cartridge C has formed therein a through opening 55 for inserting into the head cover 20a. In a manner to correspond to the portion in which the tape T and the ink ribbon R are overlapped with each other, there is disposed a platen roller so as to be rotated for driving by being fit into the platen driving shaft 25. The ink ribbon R fed out of the ribbon reel 19 is taken up by a ribbon take-up reel 54 which is disposed near the ribbon reel 19, around the head cover 20a.

When the tape cartridge C is mounted on the cartridge mounting part 6, the head cover 30a is inserted into the through opening 55, the positioning projection 24 is inserted into the center hole of the tape reel 17, and the take-up driving shaft 23 is inserted into the center hole of the ribbon take-up reel 54. As a result, the printing head 7 comes into contact with the platen roller 53 in a state in which the tape T and the ink ribbon R are sandwiched therebetween so that the written-letter printing becomes possible. The tape T that has been subjected to written-letter printing is fed to the printing tape discharge port 22.

Although not particularly illustrated, the tape T is made up of: a base material sheet (information forming layer) having formed an adhesive agent layer on the back thereof; and a release paper (peel-off layer) which is adhered to the base material layer with the adhesive agent layer. The base material sheet is made up, as seen from the front layer, of: an image receiving layer which has enhanced the stability of the ink to be transferred from the ink ribbon through heat-sensitive transfer; a base material layer which is constituted by a polyethylene terephtalate (PET) film and forms the main body of the base material sheet; and an adhesive agent layer which is constituted by an adhesive agent.

AS the tape T, there are prepared a plurality of kinds which are different in kinds (tape widths, tape colors, written-letter ink colors, tape material, or the like) and a plurality of holes (not illustrated) are provided on the rear surface of the cartridge case 51 to indicate the kinds. In correspondence to the plurality of holes, the cartridge mounting part 6 is provided with a plurality of tape recognition sensors (micro-switches) 171 which detect the kinds of the tape. It is thus so arranged that the tape kinds can be recognized by detecting the state of the tape recognition sensors 171. In this embodiment, a description is made based on sample tapes having tape widths of 24 mm (tape T1), tape width of 18 mm (tape T2), and tape width of 12 mm (tape T3) (see FIG. 6).

On the other hand, the rear case 2b has built therein an assembly for performing embossing of raised letters (raised-letter embossing section 150), and the upper portion thereof is left open in cross shape (notched opening 30) so that the raised-letter embossing section 150 (more precisely, the tape traveling passage 70, the embossing unit 80, and the tape feeding mechanism 60) is exposed. On the right of this notched portion 30, there is formed an embossing-tape inserting port 31 for manually inserting the tape T by the user. On the left thereof, there is formed the embossed tape discharge port 32 for discharging the embossed tape T.

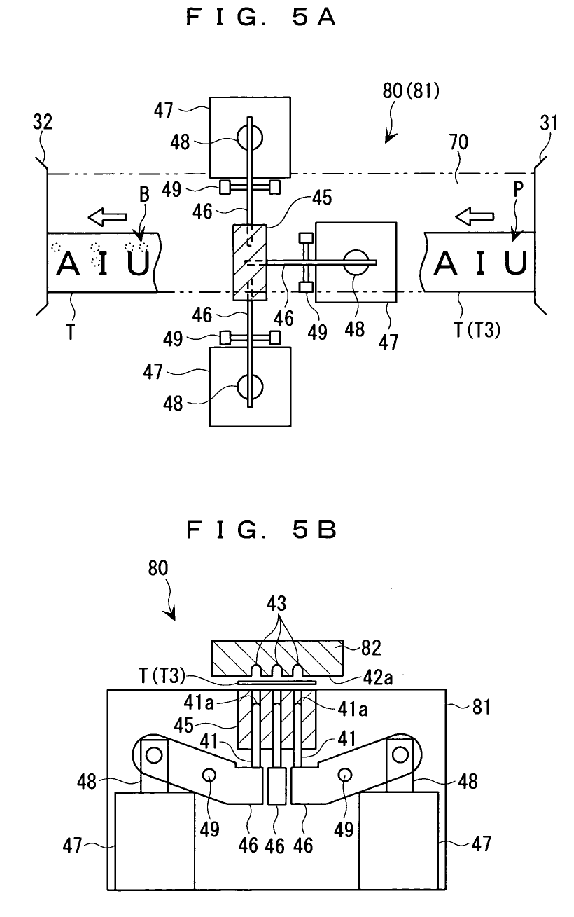

The raised-letter embossing section 150 is made up of: an embossing unit 80 which performs the embossing of the raised letters by the three embossing pins 41 (see FIG. 5B); a tape feeding mechanism 60 which feeds the tape T that has been inserted into the embossing-tape inserting port 31 toward the embossed tape discharge port 32; and a tape traveling passage 70 along which the tape T is transported. The raised letters B are formed on the tape T which is fed along the tape traveling passage 70, by selectively driving the three embossing pins 41 by means of the embossing unit 80.

The embossing unit 80 is made up, as shown in FIGS. 5A and 5B, of: an embossing member (embossing head) 81 which is disposed on the rear side of the tape T and which has built therein the above-described three embossing pins 41; and an emboss-receiving member 82 which receives the embossing pins 41 at a position which lies opposite to the embossing member 81 in a state in which the tape T is sandwiched therebetween. The embossing unit 80 is fixed to the lower end portion (as seen in FIG. 5B) in the widthwise direction of the tape traveling passage 70.

The embossing member 81 is provided with three embossing pins 41 which are arranged at a pitch of 2.4 mm in the tape widthwise direction (widthwise direction of the tape). These three embossing pins 41 correspond to the three vertically disposed embossing points 201a-201c (or 201d-201f) out of six in all and are held in a posture perpendicular to the tape T by means of a guide member 45 which guides the linear motion with solenoids serving as the driving source. Head portions 41a of the embossing pins 41 are formed into a cross sectional shape such as cylindrical, hemispherical, quadrangular pyramid, or the like, with a rounded corner portion at the embossed projection 202 (see FIG. 4B).

When plungers 48 perform a linear movement by solenoids 47, arm members 46 swing about supporting members 49, whereby embossing pins 41 perform linear movements in the vertical direction (as seen in FIG. 5B) toward the tape T. The three solenoids 47 connected to the respective three arm members 46 are disposed so as to be positioned at apexes of a triangle. The emboss-receiving member 82 has formed, on a surface 42a facing the three embossing pins 41, three recessed portions 3 which correspond to the three embossing pins 41. The embossing pins 41 and the emboss-receiving member 82 thus form embossed projections on the tape T.

As shown in FIG. 6, the raised-letter embossing section 150 is further provided with: guide members 71, 72 which guide the transporting of the tape T; a transparent type of front end detection sensor 91 which detects the front end of the tape T; and a reflection type of front-and-rear recognition sensor 92 (detection sensor) which detects the front-and-rear recognition information for recognizing the front and rear of the tape T. As the front-and-rear recognizing information D, there is marked a black circle (•) near the lower end (as seen in FIG. 6) at the front end of the tape T. According to this black circle, the direction of inserting the tape (front side) is indicated.

The embossing-tape inserting port 31 is capable of receiving the insertion of tape T1, T2, and T3 (tape width 24 mm, 18 mm, 12 mm) in the order of larger ones downward. The largest width of tape T1 is guided by the upper and lower guides 71, 72 (as seen in FIG. 6), and the other tapes T2, T3 are guided by the lower guide 71 only. The tape is manually fed by the user until the front end reaches the tape feeding mechanism 60 (feeding roller 61) or up to the position that allows for insertion. Then, by depressing the tape-feed start key on the keyboard 3, the feeding of the tape T3 by the tape feed mechanism 60 is started.

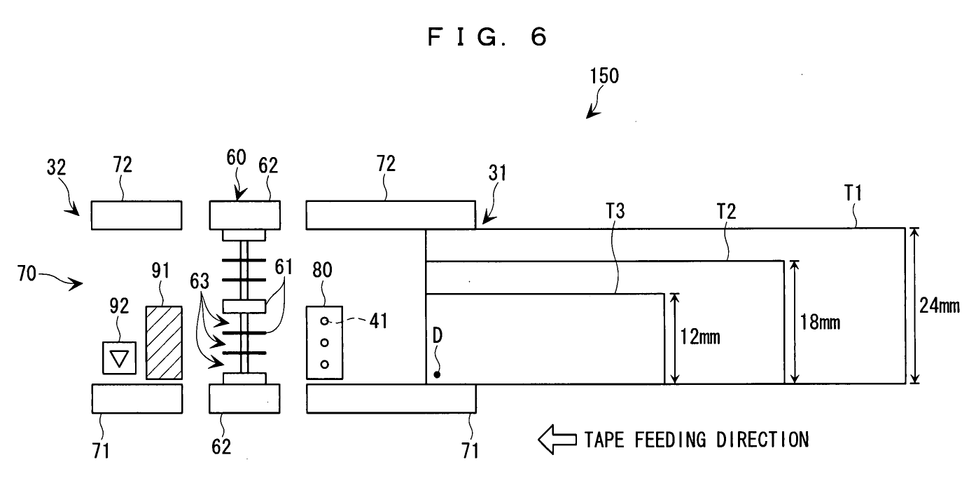

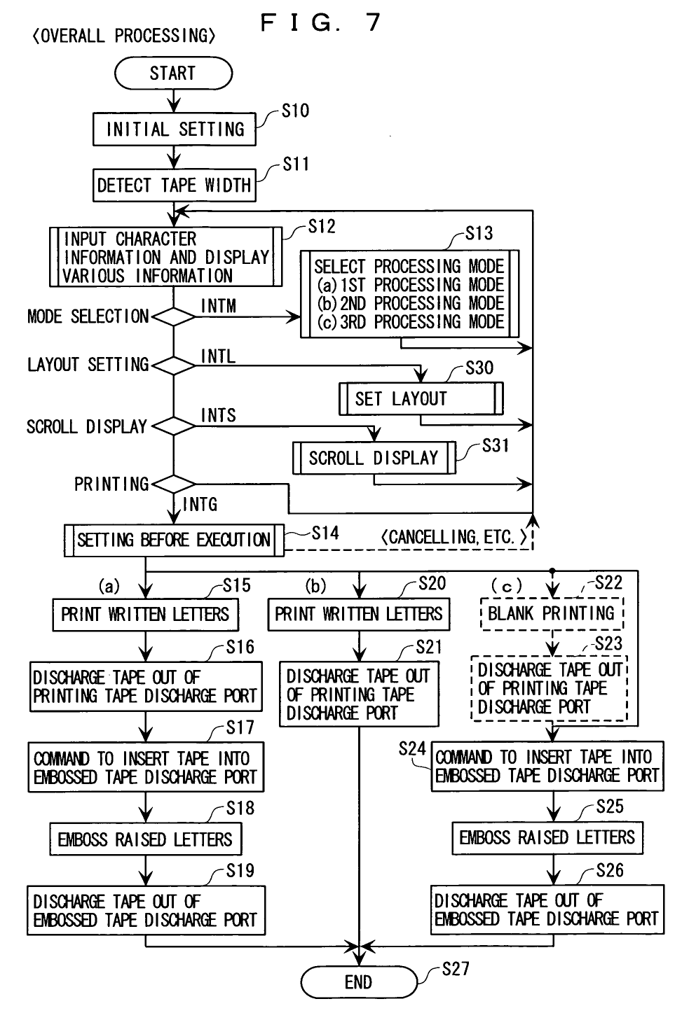

Description will now be made about an overall processing of the label forming apparatus 1 with reference to FIGS. 7 through 9. As shown in FIG. 7, when the processing starts by the depression of the power key (power ON), an initial setting is made (S10) by restoring each of retreated control flags to return to the state of last-time power OFF. Detection is made of the kind of the tape (S11) based on the tape recognition sensor 171 (see FIG. 3). Then, the character information is inputted by data input from the keyboard 3 (or an outer apparatus such as personal computers, or the like), and various information is displayed in the form of an editing screen, or the like (S12).

By mode selection command from the keyboard 3 (mode key input) or by command input from an outside apparatus, there will be generated a mode interrupt (INTM). The processing of the process mode selection will be started so that one of the first processing mode (both written letters and raised letters), the second processing mode (only written letters), and the third processing mode (only raised letters) is selected (S13).

When a layout setting interrupt is generated (INTL) by layout setting command (layout key input) or by command input from an outside apparatus, the processing for layout setting is started (S30). When scroll interrupt is generated (INTS) by scroll display command (scroll key input), the processing of scroll display is started (S31). When printing interrupt is generated (INTG) by printing/enter command (print key input) or command input from an outside apparatus, the setting before execution is started up (S14).

In the layout setting (S30), the following main setting is made, i.e., based on the result of tape width detection (S11) and the result of process mode selection (S13), the layout of written-letter printing region (printing layout portion) Ep and the raised-letter embossing region (embossing layout portion) Eb on the tape T. Namely, setting is made of: the length of each of the layout portions (printing layout portion length PL and embossing layout portion length BL); and common layout portion length CL which is ultimately reflected on the label length to suit the longer of the printing layout portion length PL and the embossing layout portion length BL (see FIG. 10C). Aside from the above, other setting of written-letter size, or the like, such as in an ordinary word processor is performed.

In case of the first processing mode (both printing of written letters and embossing of raised letters), when the result of tape width detection is 24 mm (tape T1) as shown in FIG. 9A, any one of the following layout is selected, i.e., a layout in which the printing layout portion Ep is on the upper side or upper row (as seen in FIG. 9A) and the embossing layout portion Eb is on the lower side or lower row (a-1, hereinafter referred to as “raised letter on the lower row”), and a layout in which the printing layout portion Ep is on the lower side (looks to be on the “upper row” in FIG. 9A, but is actually on the “lower row” because the tape therein is illustrated in an inverted posture of upside down) and the embossing layout portion Eb is on the upper side or upper row (a-2, hereinafter referred to as “raised letter on the upper row”). The “upper row” and the “lower row” of the tape T is defined based on a posture of the tape T when the tape recognizing information D is directed in the tape inserting direction (i.e., looking to the left) and when the surface on which the information is formed looks to the front side (i.e., in a state of the right or true side up).

When the tape width is 18 mm (tape T2) as shown in FIG. 9B, either of the layout is selected between the raised letter on the lower row (b-1) and the raised letter on the upper row (b-2). In this case, the length in the tape width direction of the printing layout portion Ep becomes smaller to suit the tape width. In the above-described cases, aside from the layout in which the raised letter and the written letter are disposed in parallel with each other (hereinafter referred to as “written- and raised-letter parallel layout”), setting can be made by selecting a layout in which the written letter and the raised letter are disposed in an overlapped relationship (hereinafter referred to as “written- and raised-letter overlapped layout”).

When the tape width is 12 mm (tape T3) as shown in FIG. 9C, the tape width is equivalent to the minimum length in which one frame of 201 of raised letter (length in the tape width direction) can be embossed (see FIG. 4A). Therefore, only the layout is possible in which the printing layout portion Ep and the embossing layout portion Eb are overlapped, irrespective of selection and setting of the raised letter on the upper row/lower row or written- and raised-letter parallel/overlapped layout.

In the setting before execution (S14), final confirmation, or the like, is made of each setting such as the setting of plotting layout as required at the time of actual written-letter printing and the raised-letter embossing. When the printing interrupt has occurred (INTG) without the mode selection interrupt or the layout setting interrupt, a selection is made, as default, of the mode as set last time (first processing mode, raised-letter on the lower row, written-letter parallel layout at the initial setting). Then, when the setting before execution (S14) is finished, the processing of the actual written-letter printing and the raised-letter embossing is started.

In other words, as shown in FIGS. 7 and 8A, in case of the first processing mode (S13: (a)), printing of the written letters P (written-letter printing) is performed by the written-letter printing section 120 (S15). Then, the tape T is discharged out of the printing tape discharge port 22 (S16), and a command to insert the tape into the embossing-tape inserting port 31 is displayed on the display 4 (S17). This display may alternatively be made by means of an indicator or an LED. When the tape T is manually inserted by the user into the embossing-tape inserting port 31 according to the command to insert the tape, the raised letters B are embossed by the raised-letter embossing section 150 (raised-letter embossing) (S18), and the embossed tape T is then discharged out of the embossed tape discharge port 32 (S19), whereby the processing is finished (S27). At this time, in the raised-letter embossing section 150, the detection is made of the front-and-rear recognizing information D so that the raised-letter embossing direction is determined depending on the detection result and the set layout. If the tape inserting direction is wrong, no embossing is performed.

In the case of the second processing mode (S13: (b)), the written-letter printing is made by the written-letter printing section 120 (S20). The tape T is discharged out of the printing tape discharge port 22 (S21), whereby the processing is finished (S27). In other words, in the second processing mode, as shown in FIG. 8B, the tape T paid out of the mounted tape cartridge C is fed to the written-letter printing section 120, whereby the written letters P are printed. When the second processing mode is selected, the printing of the front-and-rear recognizing information D may be omitted.

In the case of the third processing mode (S13: (c)), a command to insert the tape to be embossed into the embossing-tape inserting port 31 is displayed on the display 4 (S24). After the raised letters B are embossed upon insertion of the tape by the user (S25), the embossed tape T is discharged out of the embossed tape discharge port 32 (S26), whereby the processing is finished (S27).

In other words, as shown in FIG. 8C, in the third processing mode, embossing of the raised letters B is performed on the rectangular tape T (i.e., the tape that is cut into an arbitrary length) when the tape T is fed by manual insertion into the raised-letter embossing section 150. In the same manner as in the first processing mode, the embossing direction is determined based on the detection result of the front-and-rear recognizing information D and the layout as set. If the direction of tape insertion is wrong, embossing is not performed.

In the third processing mode, the detection of the front-and-rear recognizing information D may be omitted. It may thus be so arranged that the detection of the front-and-rear recognizing information D is selectable. Further, in order to obtain a rectangular tape T for manual insertion, the following arrangement may also be made as shown in dotted lines, before giving a command of inserting the tape (S24). Namely, after having performed blank (or void) printing (i.e., only tape feeding without printing) (S22) in place of written-letter printing in the first processing mode, the printing tape is discharged from the printing tape discharge port 22 (S23). The discharged tape T (after tape-cutting) is thus used as the rectangular tape T for manual insertion. Otherwise, by mounting the tape cartridge C on the upstream side of the raised-letter embossing section 150, the raised letters may be embossed on the elongated tape paid out of the tape cartridge C. It is also possible to perform the written-letter printing and the raised-letter embossing not on the basis of the character information but on the basis of different character information.

In the label forming apparatus 1, it is possible to display in the display 4 a corresponding preview display screen (hereinafter referred to as a monitor screen) aside from an ordinary display screen such as the text editing screen (hereinafter referred to as an ordinary screen), or the like. Therefore, the image of the label as visually represented by the written-letter printing and by the raised-letter embossing when transferred to the performing processing such as printing at each point of time of editing, or the like, can be confirmed before performing the printing, or the like.

For example, in the ordinary screen, when the printing key is depressed and interrupt occurs (INTG) in a state of text editing screen display in which the letter (character) string “AZUSA” (a pet name of a Japanese express train) has been inputted and determined (the state of S12 in FIG. 7), the written-letter printing is performed (S20) according to the image (written-letter printing data) Gp01 in FIG. 10D in case the second processing mode (only written-letter printing) has been selected. The tape T is discharged out of the printing tape discharge port 22 (S21), and the processing is finished (S27). In the examples illustrated in FIGS. 10A-10E as well as in FIGS. 11A-11G, written letters of Japanese hiragana “AZUSA” are left as they are in combination with the corresponding raised letters so as to show the mutual positional relationship. The same applies to FIGS. 11A-11G. Embossed or raised letter therein corresponds to “AZUSA” as represented in hiragana.

Therefore, in a state of editing by displaying the above-described character string “AZUSA,” the text editing screen is displayed on the ordinary screen, and also the visual representation of the label Lp01 which is expected to be formed in case the printing is performed from that state, is displayed on the monitor screen for the purpose of preview. Therefore, the image in visual representation of the label Lp01 which is to be formed after performing the printing job, or the like, can be confirmed prior to the performing.

The label forming apparatus 1 is capable of arbitrarily setting the size allocation between the ordinary screen and the monitor screen within the display 4. In the example as explained hereinabove with reference to FIG. 10D, the length of the monitor screen may be set so as to enable to display as much as possible of the entire image Gp01, or the like. Or else, in case the image Gp01, or the like, is large (i.e., in case the label is long), only a part thereof may be displayed.

In case the monitor length (length of display range; hereinafter also referred to as “monitor length”) SL is set to be shorter than the length of the printing layout portion length PL of the image Gp01 in FIG. 10D, the label forming apparatus 1 can display the image Gp01, or the like, on the monitor screen in a scrolled manner by scroll display command (inputting through scroll key). In case the scroll interrupt occurs by the scroll display command (INTS in FIG. 7), the scroll display processing is started up (S31), whereby the image Gp01, or the like, is displayed in a scrolled manner by circulating within the monitor length SL.

The same applies to the third processing mode (i.e., only raised letters). In a state of editing in which the character string “AZUSA” is displayed, if the enter key is depressed by generating the printing interrupt (INTG), the tape insertion command is displayed (S24 in FIG. 7). Embossing is then performed, e.g., according to the image (raised-letter embossing data) in FIG. 10B (S25-S27), whereby the label Lb0 having an embossing layout portion length BL is formed. The visual representation of the label Lb0 is thus displayed on the monitor screen as a preview corresponding to the display on the ordinary screen. With the scroll display command (scroll interrupt; INTS in FIG. 7), the processing of the scroll display is started up (S31), whereby the image Gb0, or the like, is displayed in a scrolled manner within the range of the monitor length SL.

In case of the first processing mode (both written-letter printing and raised-letter embossing), when printing interrupt occurs (INTG on FIG. 7) in a state of editing while displaying the above-described character string “AZUSA,” the common layout portion length CL is set corresponding to the embossing layout portion length BL which is longer than the original printing layout portion length PL. Written letters are printed (S15-S16 in FIG. 7) according to the image (written-letter printing data) Gp0 equivalent to the common layout portion length CL. Tape insertion command is then displayed (S24 in FIG. 7) and the raised-letter embossing is performed (S18-S19, S27) according to the image (raised-letter embossing data) Gb0, whereby the label L00 of an external appearance G00 having a common layout portion length of CL is formed.

If the visual representation of the label L00 is displayed on the monitor screen having a monitor length of SL for the purpose of preview to correspond to the display of the ordinary screen while editing the above-described character string “AZUSA,” and the scroll interrupt occurs (INTS in FIG. 7), the processing for scroll display is started up (S31). The image G00 to suit the external appearance within the range of the monitor length of SL is displayed in a scrolled manner.

For the tape width of 12 mm (tape T3, see FIG. 9C) in case of the first processing mode (both written-letter printing and raised-letter embossing), the printing layout portion Ep and the embossing layout portion Eb are overlapped with each other. Therefore, even if the display is made of the image G00 in FIG. 10C as it is, the overlapped portions cannot be confirmed (especially on the embossed-letter side). In the illustrated example, in order to facilitate understanding, display is made so that the embossed points can be distinguished from the written letters “AZUSA.” However, if both are similarly displayed (e.g., in the same thickness), the result will be as shown in FIG. 10E. It is to be noted that this displaying is made easier than the actual state of displaying. Although this kind method of displaying can be actually used, the following explanation is made on the assumption that the actual displaying is made as shown in FIG. 10E.

The label forming apparatus 1 is arranged such that the mode of scrolling of the written letters (Gp0 in FIG. 10A) and the mode of scrolling of the raised letters (Gb0 in FIG. 10B) are different from each other. Both the images Gp0 and Gb0 can thus be arranged to be easily confirmed independently even in case they are overlapped with each other as shown in FIG. 10C.

In other words, in the scroll display corresponding to the above-described label L00, as shown in FIG. 11, the written-letter image Gp0 of the character “AZUSA” is continuously scrolled at a constant speed (see one-dot line). The raised-letter image Gb0, on the other hand, is scroll-displayed in a discontinuous (intermittent) manner and in a manner to catch up with the written-letter image Gp0 on the way (the state relatively in reference positions of FIGS. 11A, 11D, 11G; hereinafter referred to as “reference state”).

In this case, by displaying of intermediate states (transitional states of deviating from the reference state as in FIGS. 11B, 11C, 1E, 11F), the overlapped portions which cannot be seen in the reference state (especially the raised-letter side) are displayed. Both images Gp0 and Gb0 can thus be easily confirmed independently.

As the way of the above-described deviation (i.e., the deviation in which the written letters precede), the following may be considered. Namely, in order to attain the deviation to facilitate the looking at (understanding of) the raised-letter image which lies on the lower side of the overlapping, deviation may be of such a degree that one row of three vertically arrayed embossing points (points 1-3 or 4-6) is visible (see FIGS. 11C, 11F). Alternatively, deviation may be made by an amount equivalent to one frame, two frames inclusive of the space between the two frames, a plurality of frames corresponding to the entire length BL of one unit of raised letters, as well as a plurality of frames which is other than integer-multiple of numbers, such as 1.5 frame.

The distance of movement at one time of the following side (i.e., the above-described raised-letter side) need not be an integer-multiple of the preceding side (i.e., the above-described written-letter side). In this case, it may be so arranged that the following side catches up with the preceding side at a position corresponding to the least common multiple of one time of movement distance of the preceding side and one time of movement distance of the following side. Alternatively, the distance of one time of movement of one of the preceding side and the following side, or both may be a plurality of values which meet the condition that a predetermined value showing the catch-up position becomes the total value thereof. For example, let us omit the unit of movement (e.g., dot line which is described hereinafter). The distance covered by fifteen (15) times of movements each moving one (1) at a time is caught up with by five times of movements which is equal to the movement distance of 1+2+3+4+5=15. The timing of performing these scroll movements (moving cycle) need not be regular but may be made to be attained in total of a plurality of times. The movement distance and the moving cycle may be arranged to be arbitrarily set taking into consideration the written-letter image and the raised-letter image which are in scroll-display, or the way of their overlapping, or the like.

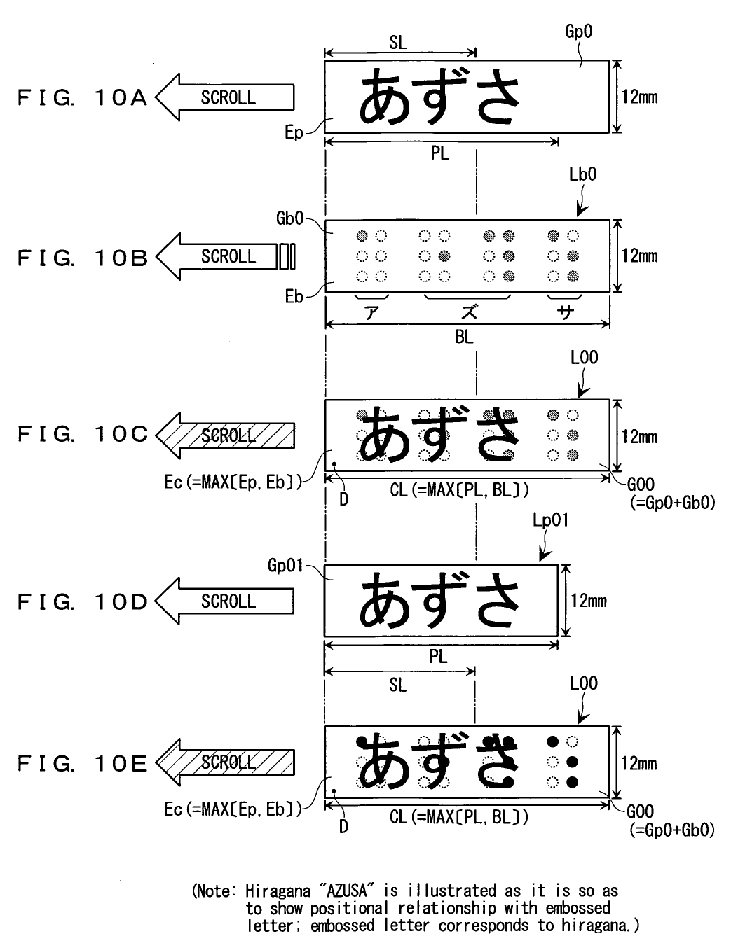

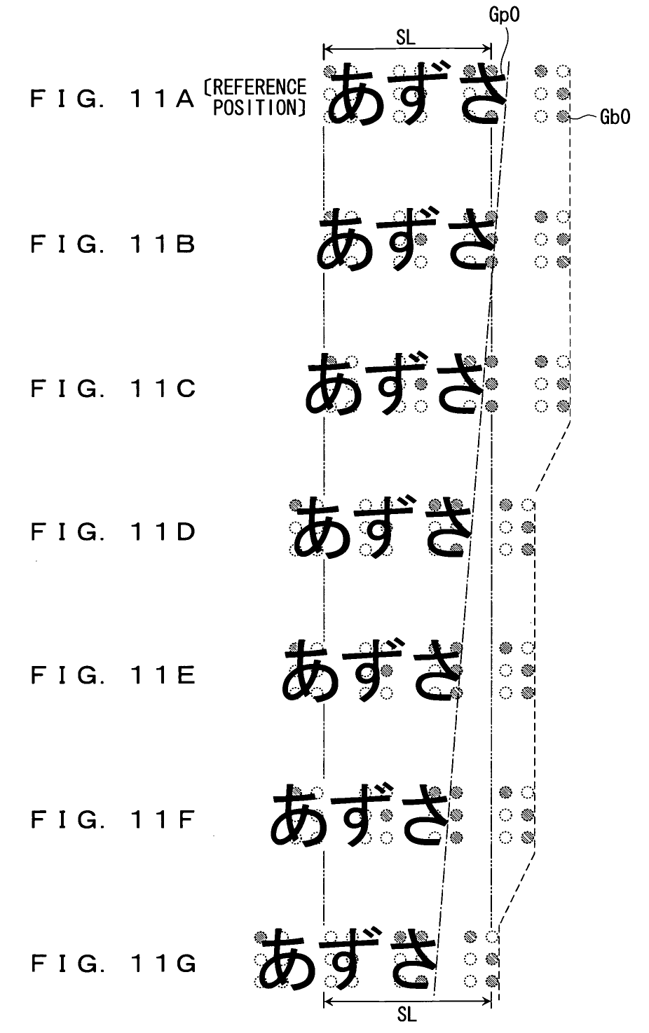

Another embodiment (second example) is described with reference to FIG. 12. Let us assume that the character string “F15” is formed by performing one or both of the written-letter printing and the corresponding raised-letter embossing. In the second processing mode (only written-letter printing), a label Lp11 having printed thereon the written letters can be formed based on the image (written-letter printing data) Gp11 in FIG. 12D. The image Gp11 can thus be displayed for the purpose of preview and in a scrolled manner. In the third processing mode (only raised-letter embossing), a label Lb1 having embossed thereon the raised letters based on the image (raised-letter embossing data) Gb1 can be formed. The image Gb1 can thus be displayed for the purpose of preview and in a scrolled manner.

In the first processing mode (both written-letter printing and raised-letter embossing), there can be formed a label L10 in which both the written-letter printing and the raised-letter embossing are performed based on the written-letter image Gp1 in FIG. 12A whose length is adjusted to the image Gb1 and the raised-letter image Gb1. The image can thus be displayed for the purpose of preview and in a scrolled manner. At the time of scroll-display, both the written-letter image Gp1 and the raised-letter image Gb1 can be separately confirmed due to different modes of displaying in a scrolled manner.

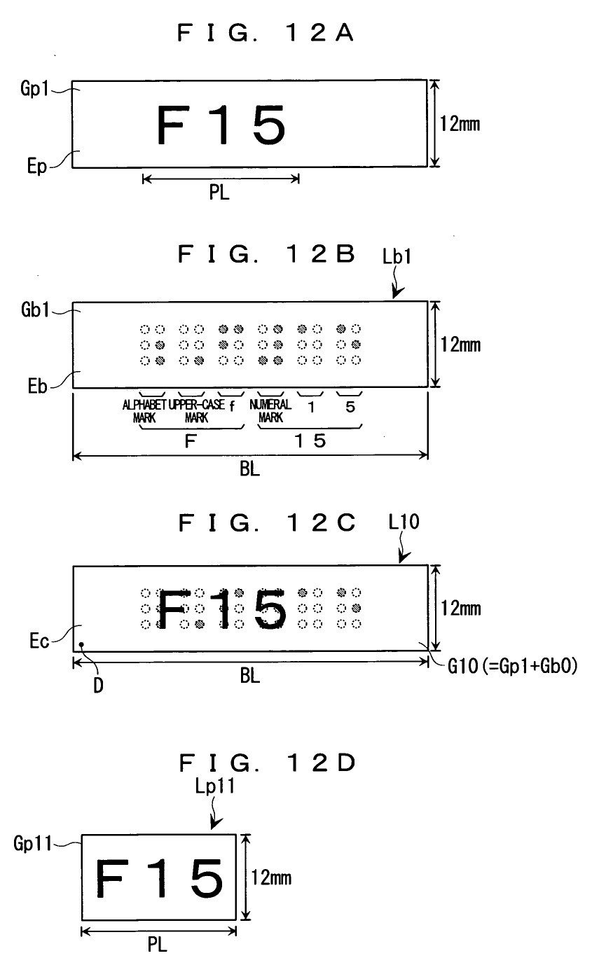

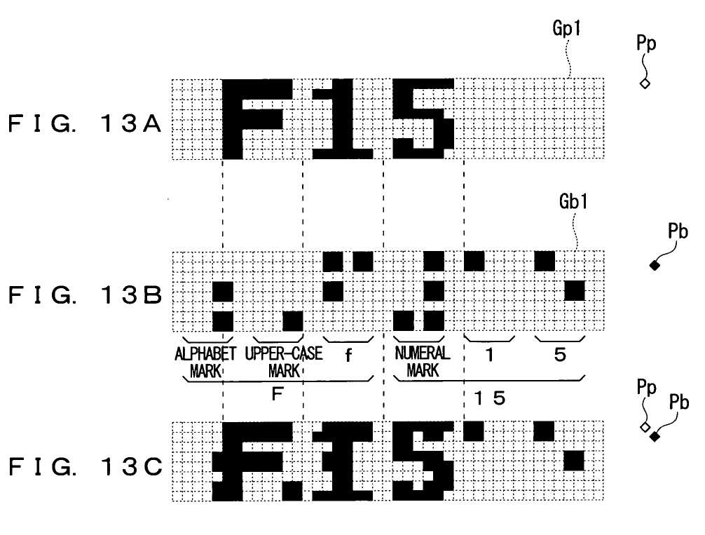

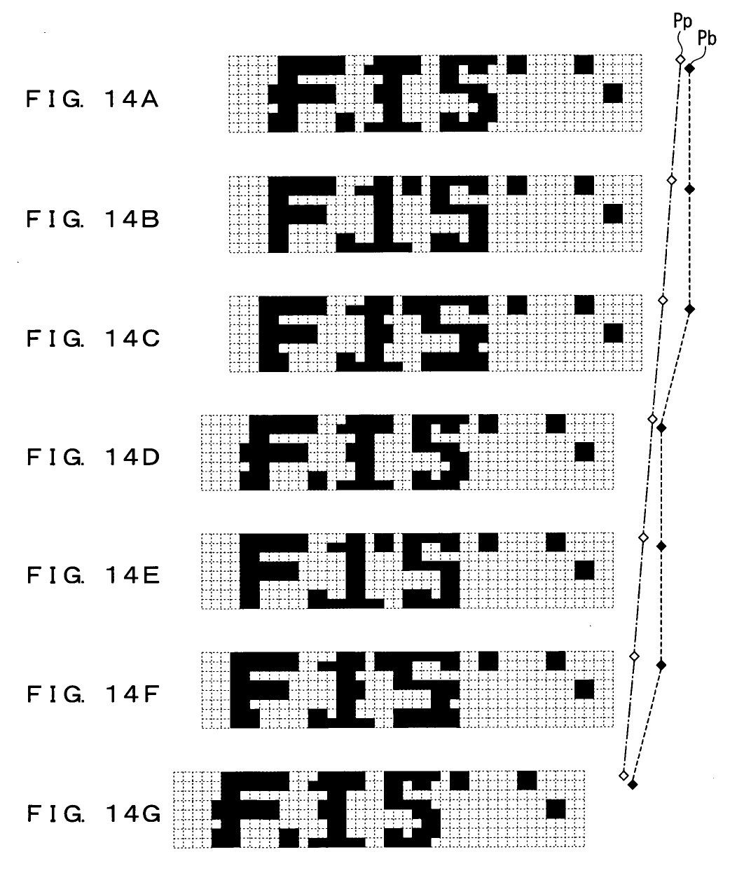

A description will now be made about the manner of scroll-displaying when viewed at the level of dot matrices of image data at the time of setting the first processing mode (both written-letter printing and raised-letter embossing). In other words, the manner of image processing of the monitor image is explained with reference to FIGS. 13 and 14.

As shown in FIG. 13, the embossing point is shown in a square of two-dot×two-dot in order to show each dot (pixel) on a large scale. It may however be displayed substantially in a circle which is similar to each embossed pint of the actual raised letter when displayed in detailed dot matrix. Here, one frame occupies the space equivalent to five dot lines, and the space between the frames occupies the space equivalent to two blank dot lines. Further, in order to facilitate the recognition of movement in position by scrolling, written-letter image data (image) Gp1 and the raised-letter embossing data (image) Gb1 are respectively provided with an imaginary mark point Pp and an imaginary mark point Pb. The movement path of the mark point Pp for the written letters is shown in one chain line and the movement path of the mark point Pb for the raided letters is shown in a dotted line. The reference state is as shown in FIG. 13C.

When scrolling is started, as shown in FIG. 14, only the written-letter image Gp1 side is moved by an amount equivalent to two steps, each processing (1 step: to be processed in, e.g., 0.02 sec.) by an amount equivalent to one-dot line (FIGS. 14B, 14C). When movement is made in the next one step by an amount equivalent to one-dot line, the raised-letter image Gb1 is moved by an amount equivalent to three-dot line. The raised-letter side will thus catch up with the written-letter side, thereby returning to the reference state (FIG. 14D). When movement of only the written-letter Gp1 side is similarly made from this state by an amount equivalent to two steps, each processing by an amount equivalent to one-dot line (FIGS. 14E, 14F), and when movement is further made by an amount equivalent to one-dot line at one step, the raised-letter image Gb1 is moved by an amount equivalent to three-dot line to thereby return to the reference state (FIG. 14G).

In other words, in the above-described example, the cycle of performing the scroll (every three steps) on one side (raised-letter side) is made three times the cycle of performing the scroll (every one step) on the other side (written-letter side). It is also so arranged, on the other hand, that the distance of movement (three-dot line) on the raised-letter side (said one side) at every scrolling is made three times the distance of movement (one-dot line) on the written-letter side (said the other side). As a result, the raised-letter side catches up with the other side (written-letter side) each time of scrolling of said one side (raised-letter side). The distance of movement and the cycle of performing scroll (cycle of movement) may be arbitrarily set taking into consideration the overlapping of the images in the course of scroll display.

As described in detail hereinabove, the label forming apparatus 1 of this embodiment displays in scrolled manner the written-letter image and the raised-letter image within the monitor screen (i.e., within a single display screen). Therefore, the visual representation of the written letters and the visual representation of the raised letters can be grasped substantially at the same time. In addition, even if the monitor length SL is small, and even if the visual representation is likely to be an elongated line in the case of the raised letters, the entire visual representation can be grasped. This invention can be easily applicable not only to the label forming apparatus 1 but also to other apparatuses whose display screens are small.

In the above-described embodiment, the written-letter image and the raised-letter image are displayed in different scroll modes (strictly speaking, in different cycles of performance and movement distances). Therefore, the relative position of the two images deviate from each other, resulting in easy grasping of the respective images. In this case, the reference position is defined to be the relative position that is attained after performing the printing and the embossing. Then, the reference position is made to be attained on the way of scroll displaying. The image to be obtained after performing the actual written-letter printing and the raised-letter embossing can thus be grasped prior to actually performing the printing and embossing operations.

In the above-described embodiment, the arrangement is made such that the written-letter image side is caught up with by the raised-letter image side. The opposite arrangement may also be employed. In addition, instead of the “intermittent catch-up style” in which the one which moves behind in scrolling catches up with the other each time of scroll movement, there may be employed a circulation-scroll display in which the distance between the two constantly varies from time to time, or one may follow the other or precede the other. Variety of displaying of the relative relationship can thus be made possible, thereby facilitating independent grasping of the respective images.

The mode of scrolling the written-letter image and the raised-letter image has been described as the cycle of performing the scrolling (unit movement cycle) and the moving distance (unit movement distance). As an alternative scroll mode, there may be considered a mode of scrolling display while one is flashing and the other is in an ordinary state. Further, there was shown an example of a tape T (T3) having a width of 12 mm. Alternatively, the tape may be of a width of 18 mm (tape T2) or 24 mm (tape T1). In these cases, a selection can be made of a mode of the raised letter on an upper row/lower row or written letter in parallel/overlapped. In each of the cases, this invention can similarly be applicable.

Alternatively, the scroll display of only the written letter, scroll display of only the raised letter, and the scroll display of both the images (both written-letter printing and raised-letter embossing) may be performed in a predetermined order by switching operation. The direction of scrolling may be made not only in the left-and right (horizontal) direction but also in the up-and-down (vertical) direction, inclined (slanting) direction, or a combination thereof. In addition, as a mode of scrolling the written letters and the raised letters, the scroll direction may be changed on the way. In these cases, preferably, the mode of reference position showing the state after performance of printing shall be shown on the way of scroll display.

In the above-described embodiment, the label forming apparatus 1 was employed as an apparatus for processing the character information. However, this invention can be applied to other apparatuses for processing character information than for forming the label. Other pieces of paper, or the like, may also be used as the target sheet material, and the target sheet material need not be an elongated one such as a tape, or the like. In addition, in the above-described embodiment, a description was made about an arrangement having one line of written letters and one line of raised letters. The arrangement may alternatively be made so that both letters are made up of a plurality of lines. Or else, only one of the lines may be made up of a plurality of lines and the other thereof is arranged to correspond to one of the lines, or they need not have correlation among lines.

The function as the apparatus for processing character information and as the image processing apparatus employed in this embodiment, as well as various processing methods (character information processing method, image processing method, or the like) is applicable not only to the above-described label forming apparatus 1, but also to a program which is processed by various apparatuses that can be processed according to a program, and also to a memory medium such as a CD, MD, DVD, or the like, for storing therein that kind of program. When such a program is performed by storing it into, or by reading it out of, the memory medium, the visual representation of the result of performing both the written-letter printing and the raised-letter embossing can be easily grasped.

What is claimed is:

1. A method of processing an image comprising displaying a raised-letter image which visually represents a raised letter to be embossed on a target sheet material, wherein said displaying is made on a display screen in a scrolled manner.

2. A method of processing an image comprising displaying images of both a raised letter and a written letter to be embossed and to be printed, respectively, on a common target sheet material as a single unit in a scrolled manner, wherein a raised-letter image which visually represents the raised letter and a written-letter image which visually represents the written letter are displayed in scroll modes which are different from each other.

3. The method according to claim 2, wherein the raised-letter image and the written-letter image are displayed in a scrolled manner by respective intermittent movements, and wherein the scroll mode of the raised letter and the scroll mode of the written letter are different from each other in a movement cycle of the intermittent movements.

4. The method according to claim 3, wherein one movement cycle is integer times of the other movement cycle.

5. The method according to claim 4, wherein a unit movement distance according to said one movement cycle is integer times of a unit movement distance according to the other movement cycle.

6. An apparatus for image processing in which images of both a raised letter and a written letter to be embossed and to be printed, respectively, on a common target sheet material are displayed as a single unit on a display screen in a scrolled manner, said apparatus comprising:
raised-letter scrolling means for displaying in a scrolled manner a raised-letter image which visually represents the raised letter;
written-letter scrolling means for displaying in a scrolled manner a written-letter image which visually represents the written letter;
control means for controlling the raised-letter scrolling means and the written-letter scrolling means, wherein the control means displays the raised-letter image and the written-letter image in scroll modes which are different from each other.

7. An apparatus for processing character information comprising:
image processing means for performing the method of processing an image according to claim 1;
embossing means for embossing the raised letter on the target sheet material; and
printing means for printing the written letter on the target sheet material.

8. A program capable of performing the method of processing an image according to claim 1.

9. A memory medium which stores the program according to claim 8 in a manner readable by an apparatus which is capable of being processed by a program.
